(19) United States
(12) Patent Application Publication
(10) Pub. No.: US 2022/0374216 A1
(43) Pub. Date: Nov. 24, 2022

(54) METHOD OF MANUFACTURING INFORMATION PROCESSING APPARATUS AND MOBILE COMPUTER

(71) Applicant: Lenovo (United States) Inc., Morrisville, NC (US)

(72) Inventors: Takashi Sugawara, Kanagawa (JP); Alan Frederick Arnold, Morrisville, NC (US); Yusuke Taira, Kanagawa (JP)

(73) Assignee: Lenovo (United States) Inc., Morrisville, NC (US)

(21) Appl. No.: 17/325,784

(22) Filed: May 20, 2021

(51) Int. Cl. G06F 8/61; G06F 3/06

(52) U.S. Cl. CPC G06F 8/61; G06F 3/0679; G06F 3/0647; G06F 3/0604

(57) ABSTRACT

A method of manufacturing an information processing apparatus includes storing, in a first storage area of a solid-state drive (SSD) of the information processing apparatus, an installation program which when executed causes the information processing apparatus to install preload data, executing the installation program to install the preload data at least partially in a second storage area of the SSD, and after executing the installation program, moving portions of the preload data stored in the second storage area to the first storage area of the SSD. The first storage area is configured to store single bit cells in which one bit of data is stored in one memory cell, and the second storage is configured to store multi-bit cells in which multiple bits of data are stored in one memory cell.

### TECHNICAL FIELD

The present disclosure relates to a method of manufacturing an information processing apparatus, and a mobile computer.

### BACKGROUND

Some information processing apparatuses such as personal computers are shipped with an OS (Operating System) and predetermined application programs pre-installed by default. Depending on circumstance, information processing apparatuses may be stored (e.g., in a warehouse) for a long time prior to shipping to the end user. In this case, it would be desirable to improve the data retention reliability of the pre-installed data during storage.

### BRIEF DESCRIPTION OF DRAWINGS

FIG. 1 is a diagram illustrating an example of the main hardware configuration of an information processing apparatus and a solid-state drive (SSD).

FIG. 2 is a diagram illustrating a configuration example of a storage area of the SSD.

FIG. 3 is a table illustrating comparisons of the characteristics of SLC and QLC of the SSD.

FIG. 4 is a flowchart illustrating an example of processing in a pre-installation process of the information processing apparatus.

FIG. 5 is a diagram illustrating an example of state transitions of the SSD in the pre-installation process of the information processing apparatus.

FIG. 6 is a flowchart illustrating an example of processing in a pre-installation process of the information processing apparatus.

### DETAILED DESCRIPTION

Embodiments of the present disclosure will be described below with reference to the accompanying drawings.

### First Embodiment

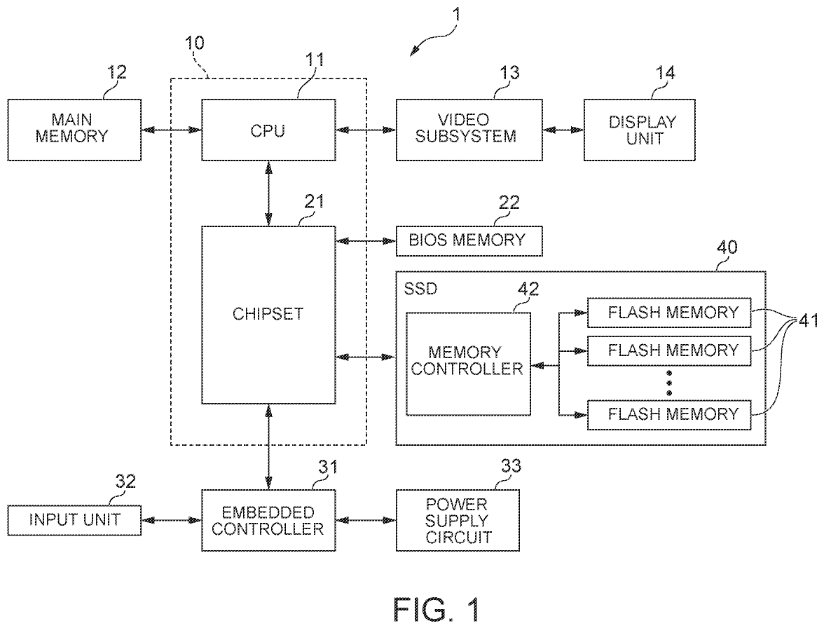

FIG. 1 is a diagram illustrating an example of the main hardware configuration of an information processing apparatus 1 and an SSD 40 according to a first embodiment.

As illustrated in FIG. 1, the information processing apparatus 1 is, for example, a laptop personal computer, and includes a CPU 11, a main memory 12, a video subsystem 13, a display unit 14, a chipset 21, a BIOS memory 22, an embedded controller 31, an input unit 32, a power supply circuit 33, and the SSD 40.

The CPU (Central Processing Unit) 11 executes various kinds of arithmetic processing by program control to control the entire information processing apparatus 1.

The main memory 12 is a writable memory used as reading areas of execution programs of the CPU 11 or working areas to which processing data of the execution programs are written. The main memory 12 is configured, for example, to include plural DRAM (Dynamic Random Access Memory) chips. The execution programs include an OS (Operating System), various drivers for hardware-operating peripheral devices, various services/utilities, application programs, and the like.

The video subsystem 13 is a subsystem for realizing functions related to image display, which includes a video controller. This video controller processes a drawing command from the CPU 11, writes processed drawing information into a video memory, and reads this drawing information from the video memory and outputs it to the display unit 14 as drawing data (display data).

The display unit 14 is, for example, a liquid crystal display to display a display screen based on the drawing data (display data) output from the video subsystem 13.

The chipset 21 includes controllers, such as USB (Universal Serial Bus), serial ATA (AT Attachment), an SPI (Serial Peripheral Interface) bus, a PCI (Peripheral Component Interconnect) bus, a PCI-Express bus, and an LPC (Low Pin Count) bus, and plural devices are connected to the chipset 21. In FIG. 1, the BIOS memory 22 and the SSD 40 are connected to the chipset 21 as examples of the devices.

Note that the CPU 11 and the chipset 21 correspond to a main control unit 10 in the present embodiment.

The BIOS (Basic Input Output System) memory 22 is configured, for example, by an electrically rewritable nonvolatile memory such as an EEPROM (Electrically Erasable Programmable Read Only Memory) or a flash ROM. The BIOS memory 22 stores a BIOS and system firmware for controlling the embedded controller 31 and the like.

The embedded controller 31 is a one-chip microcomputer which monitors and controls various devices (peripheral devices, sensors, and the like) regardless of the system state of the information processing apparatus 1. Further, the embedded controller 31 has a power management function to control the power supply circuit 33. Note that the embedded controller 31 is composed of a CPU, a ROM, a RAM, and the like, which are not illustrated, and equipped with multi-channel A/D input terminal and D/A output terminal, a timer, and digital input/output terminals. To the embedded controller 31, for example, the input unit 32, the power supply circuit 33, and the like are connected through these input/output terminals, and the embedded controller 31 controls the operation of these units.

The input unit 32 includes, for example, an input device such as a keyboard and a pointing device (e.g., a touch pad).

The power supply circuit 33 includes, for example, a DC/DC converter, a charge/discharge unit, an AC/DC adapter, and the like to convert DC voltage supplied from an external power supply such as through the AC/DC adapter or supplied from a battery into plural voltages required to operate the information processing apparatus 1. Further, the power supply circuit 33 supplies power to each unit of the information processing apparatus 1 under the control of the embedded controller 31.

The solid-state drive (SSD) 40 is a memory drive device having a rewritable nonvolatile memory to store the OS, various drivers, various services/utilities, application programs, and various data. The information processing apparatus 1 executes various information processing using data stored on the SSD 40. The SSD 40 is connected to the chipset 21, for example, through the serial ATA or the PCI-Express bus.

The SSD 40 includes plural flash memories 41 and a memory controller 42.

The flash memories 41 are, for example, NAND flash memories. Each of the flash memories 41 is equipped with charge-trap type memory cells each of which stores data, for example, by trapping electrons in a charge trapping layer without any floating gate. The memory cells in the flash memory 41 are multi-bit cells for storing multiple bits of data in one memory cell which is, for example, a QLC (Quad Level Cell). Here, the QLC is a memory cell capable of storing data corresponding to 4 bits in one memory cell by providing plural data writing threshold values.

The memory cell as the QLC in the flash memory 41 can also be made to function as an SLC (Single Level Cell). Here, the SLC is a single bit cell for storing one bit of data in one memory cell by providing one data writing threshold value.

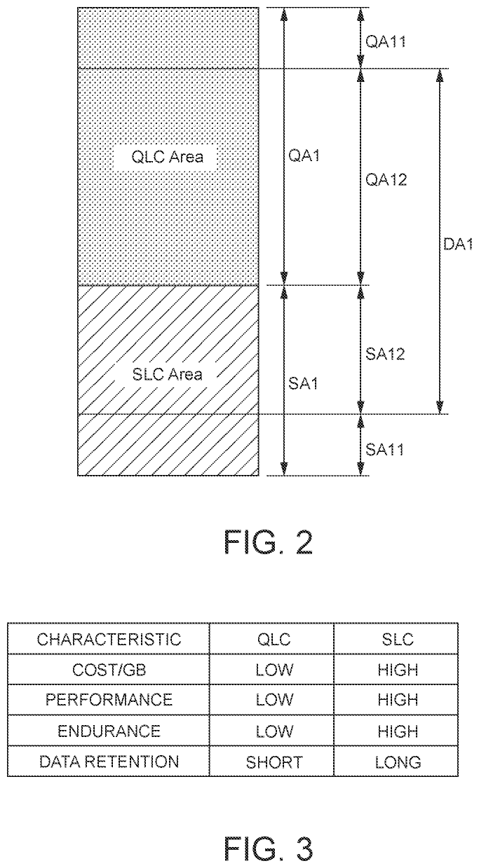

The plural flash memories 41 constitute a storage area compatible with both the QLC and the SLC. The details of the storage area of the SSD 40 will be described in detail below with reference to FIG. 2.

FIG. 2 is a diagram illustrating a configuration example of the storage area of the SSD 40 in the present embodiment.

As illustrated in FIG. 2, the storage area of the SSD 40 has an SLC area SA1 and a QLC area QA1. Note that the storage area of the SSD 40 is a storage area composed of the plural flash memories 41.

The SLC area SA1 (an example of a first storage area) is a storage area of single bit cells which is, for example, a storage area in which QLC cells are made to function as the SLCs. The SLC area SA1 has a static SLC area SA11 (static storage area) and a dynamic SLC area SA12 (dynamic storage area). The SLC area SA1 (the example of the first storage area) is used as an SLC buffer in the information processing apparatus 1.

The static SLC area SA11 is a storage area used fixedly as an SLC storage area.

The dynamic SLC area SA12 is a storage area changeable to the QLC area QA1 depending on the settings of the memory controller 42 to be described later.

The QLC area QA1 (an example of a second storage area) is a storage area of QLCs as multi-bit cells. The QLC area QA1 has a static QLC area QA11 and a dynamic QLC area QA12.

The static QLC area QA11 is a storage area used fixedly as a QLC storage area.

The dynamic QLC area QA12 is a storage area changeable to the SLC area SA1 depending on the settings of the memory controller 42 to be described later.

Note that the dynamic SLC area SA12 and the dynamic QLC area QA12 correspond to a dynamic area DA1 in which the QLC area QA1 and the SLC area SA1 are mutually changeable.

Further, note that the SSD 40 may include only dynamic storage, i.e., include only the dynamic QLC area QA12 and the dynamic SLC area SA12.

Here, differences in characteristics between the QLC and the SLC will be described with reference to FIG. 3.

FIG. 3 is a table illustrating comparisons of the characteristics of the SLC and the QLC of the SSD 40.

In FIG. 3, cost/GB (Gigabyte), performance, endurance, and data retention are illustrated as the characteristics in this order from top to bottom. The cost/GB represents the cost of storage capacity of the SSD 40 per GB, and the performance represents the level of processing capability when the information processing apparatus 1 executes information processing. Further, the endurance represents the characteristic of the number of rewritable times of the SSD 40, and the data retention represents the characteristic of the data retention period of the SSD 40.

The QLC can store data corresponding to 4 bits in one memory cell, while the SLC can store one bit of data in one memory cell. Therefore, in terms of the cost/GB, the QLC is lower than the SLC and the SLC is higher than the QLC.

Further, when data is read from the QLC, there is a need to determine the levels of plural threshold values (for example, 15 threshold values), while when data is read from the SLC, it is only necessary to determine the level of one threshold value. Therefore, the performance of the QLC is lower than that of the SLC (low performance), and the performance of the SLC is higher than that of the QLC (high performance).

Further, the endurance characteristic (the characteristic of the number of rewritable times) of the QLC is lower than the endurance characteristic of the SLC. Therefore, the endurance characteristic of the QLC is lower than that of the SLC, and the endurance characteristic of the SLC is higher than that of the QLC.

Further, the data retention characteristic (the characteristic of the data retention period) of the QLC is more likely to corrupt data than that of the SLC. Specifically, the data retention period of multi-bit cells tends to be shorter as temperature rises. Therefore, data pre-installed in multi-bit cells can be corrupted, for example, when an information processing apparatus is stored in a place with high temperature for a long period of time before shipment, such as a warehouse. Therefore, the data retention characteristic of the QLC is shorter than that of the SLC, and the data retention characteristic of the SLC is longer than that of the QLC.

Returning to the description of FIG. 1, the memory controller 42 is a processor including, for example, unillustrated CPU, ROM, RAM, and the like to centrally control the SSD 40. For example, the memory controller 42 executes processing such as control processing of a host interface (host I/F) with the chipset 21, control processing of a memory interface (memory I/F) with the flash memories 41, and data management processing of the flash memories 41.

Further, the memory controller 42 executes various processing related to the SSD 40 in response to various requests from the main control unit 10 (for example, requests by command processing). For example, the memory controller 42 has a special command to move data stored in the QLC area QA1 to the SLC area SA1. In response to the special command input from the main control unit 10, the memory controller 42 executes command processing for moving data stored in the QLC area QA1 to the SLC area SA1.

Next, a pre-installation process of pre-installation on the information processing apparatus 1 in the manufacturing method of the information processing apparatus 1 according to the present embodiment will be described with reference to the accompanying drawings.

Note that the pre-installation is processing for installing programs and data which should be preloaded (i.e. preload data for short) on the SSD 40 at the time of shipment. The programs and data preloaded on the SSD 40 at the time of shipment are called pre-installed programs and data.

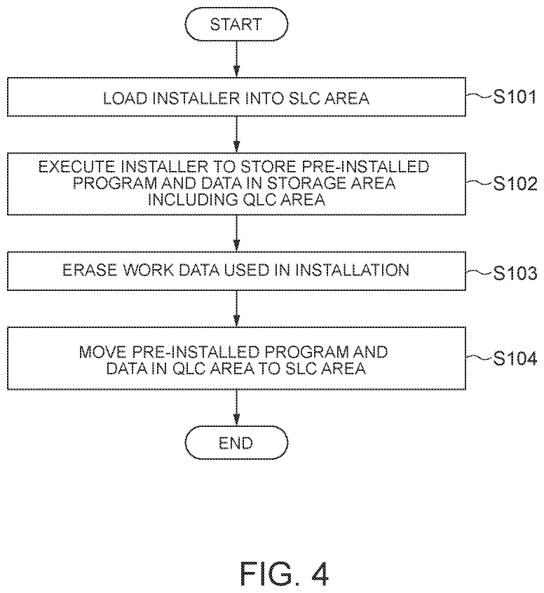

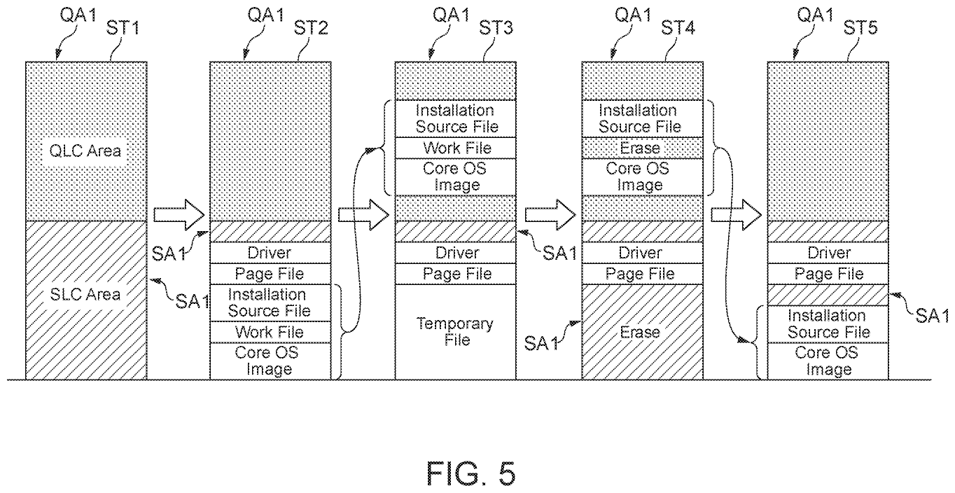

FIG. 4 is a flowchart illustrating an example of processing in the pre-installation process of the information processing apparatus 1 according to the present embodiment. FIG. 5 is a diagram illustrating an example of state transitions of the SSD 40 in the pre-installation process of the information processing apparatus 1 according to the present embodiment.

As illustrated in FIG. 4, in the processing of the pre-installation process, the information processing apparatus 1 first loads an installer into the SLC area SA1 (step S101). The main control unit 10 of the information processing apparatus 1 acquires the installer (installation program), used to execute processing for installing the programs and data preloaded on the SSD 40 at the time of shipment, from the outside through USB or the like, and stores the installer on the SSD 40. The memory controller 42 of the SSD 40 stores the installer (installation program) in the SLC area SA1. Thus, as illustrated in FIG. 5, the storage area of the SSD 40 is changed from a state ST1, in which the storage area is empty, to a state ST2 in which the installer (installation program) is stored in the SLC area SA1.

As illustrated in the state ST2 of FIG. 5, the installer (installation program) includes, for example, a core OS image, a work file, an installation source file, a page file, a driver (device driver), and the like. Here, the core OS image is, for example, image information of Windows (registered trademark).

Note that it is common practice that the main control unit 10 does not access to the SSD 40 by a logical address to specify to which physical storage area of the SSD 40 data is to be written. Therefore, the memory controller 42 of the SSD 40 may determine a storage area of the SSD 40. In currently popular technology, it is common that the memory controller 42 selects the storage area.

Next, the main control unit 10 executes the installer to store the pre-installed programs and data in a storage area including the QLC area (step S102). The main control unit 10 moves the core OS image, the work file, and the installation source file from the SLC area SA1 to the QLC area QA1 in order to secure a temporary file area in the SLC area SA1 of the SSD 40.

In other words, the memory controller 42 moves the core OS image, the work file, and the installation source file from the SLC area SA1 to the QLC area QA1 according to an instruction from the main control unit 10 in order to secure an area of a temporary file (working data area) in the SLC area SA1 as illustrated in a state ST3 of FIG. 5. The main control unit 10 uses the secured temporary file to execute installation processing of the pre-installed programs and data by the installer (installation program). Thus, the main control unit 10 executes the installation program to install the pre-installed programs and data (the programs and data to be preloaded, or preload data for short) in the storage area of the SSD 40 including the QLC area QA1.

Next, the main control unit 10 erases the work data used in the installation (step S103). As illustrated in a state ST4 of FIG. 5, the main control unit 10 erases the work data used for the installation on the SSD 40. Note that the work data in the example illustrated in FIG. 5 corresponds to the work file and the temporary file.

Next, the main control unit 10 moves the pre-installed programs and data in the QLC area QA1 to the SLC area SA1 (step S104). The main control unit 10 outputs the above-described special command to the SSD 40, and the memory controller 42 of the SSD 40 executes the special command processing to move the core OS image and the installation source file from the QLC area QA1 to the SLC area SA1 as illustrated in a state ST5 of FIG. 5.

Thus, the SSD 40 becomes such a state that the pre-installed programs and data are all stored in the SLC area SA1 (state ST5), and stored in this state until the information processing apparatus 1 is shipped. After the process of step S104, the main control unit 10 ends the processing in the pre-installation process.

It should be noted that when the preload data is stored in the SLC area SA1, the overall capacity of the SSD is reduced since the storage density of SLC is lower than that of QLC. In this case, the main control unit 10 may be configured to, upon being booted up for the first time after shipping (i.e., a so-called “out of the box” boot by a user), control the SSD 40 to move all of the preload data from the SLC area SA1 to the QLC area QA1. Then, to increase the effective capacity of the SSD 40, the main control unit 10 may further control the SSD 40 to switch some or all dynamic SLC areas SA12 to become dynamic QLC areas QA12 instead. This way, the preload data may be stored in highly reliable but low capacity SLC memory bits during storage and shipping, then moved to high capacity QLC memory bits after shipping and booting up the first time.

Note that, in the processing of FIG. 4 described above, the process of step S101 corresponds to a first manufacturing process (first step) in the pre-installation process, and step S102 and step S103 correspond to a second manufacturing process (second step) in the pre-installation process. Further, step S104 corresponds to a third manufacturing process (third step) in the pre-installation process.

As described above, the manufacturing method of the information processing apparatus 1 according to the present embodiment is a manufacturing method of the information processing apparatus 1 including the SSD 40 having the SLC area SA1 (first storage area) and the QLC area QA1 (second storage area), and the main control unit 10 (control unit) which executes information processing based on the programs and data stored on the SSD 40, the manufacturing method including the first manufacturing process, the second manufacturing process, and the third manufacturing process. Here, the first storage area (SLC area SA1) is a storage area of single bit cells in which one bit of data is stored in one memory cell. Further, the second storage area (QLC area QA1) is a storage area of multi-bit cells in which multiple bits of data are stored in one memory cell. In the first manufacturing process, the main control unit 10 stores, on the SSD 40 (for example, in the SLC area SA1), the installation program which executes processing for installing the programs and data preloaded on the SSD 40 at the time of shipment. In the second manufacturing process, the main control unit 10 executes the installation program to install, in the storage area of the SSD 40 including the QLC area QA1, the program to be pre-installed (pre-installed program) and data. In the third manufacturing process, the main control unit 10 moves, to the SLC area SA1, the program to be pre-installed (pre-installed program) and data stored in the QLC area QA1. Note that, in the first manufacturing process, the installation program may also be stored in the SLC area SA1 (first storage area).

Thus, in the manufacturing method of the information processing apparatus 1 according to the present embodiment, since the program (pre-installed program) and data to be preloaded are stored in the SLC area SA1 longer in data retention period (data retention) than the QLC area QA1 as illustrated in FIG. 3, the chance of corrupted data (including the program) pre-installed on the SSD 40 can be reduced. Therefore, in the manufacturing method of the information processing apparatus 1 according to the present embodiment, the information processing apparatus 1 can be stored, for example, in a place with high temperature for a long period of time before shipment.

For example, when the information processing apparatus 1 is stored before shipment in India or the like where daytime temperature may exceed 40° C., the pre-installation of data in the SLC area SA1 can reduce the chance of corrupted data, and hence the information processing apparatus 1 can be operated normally after shipment.

Further, in the present embodiment, when executing the installation program in the second manufacturing process, the main control unit 10 moves data stored in the SLC area SA1 to the QLC area QA1 in order to secure a working data area (for example, the work file) in the SLC area SA1. Further, when ending the execution of the installation program, the main control unit 10 erases work data stored in the working data area. Then, in the third manufacturing process, the main control unit 10 moves the programs and data, which are stored in the QLC area QA1 and to be preloaded on the SSD 40, to a free space of the SLC area SA1 including the working data area from which the work data was erased.

Thus, in the manufacturing method of the information processing apparatus 1 according to the present embodiment, the chance of corrupted data (including the program) pre-installed on the SSD 40 can be reduced while executing pre-installation efficiently by securing the working data area in the SLC area SA1 high in performance.

Further, in the present embodiment, the SSD 40 can execute command processing (special command processing) for moving the programs and data stored in the QLC area QA1 to the SLC area SA1. In the third manufacturing process, the main control unit 10 requests the SSD 40 to execute the command processing, and the SSD 40 executes the command processing to move the programs and data to be preloaded from the QLC area QA1 to the SLC area SA1.

Thus, in the manufacturing method of the information processing apparatus 1 according to the present embodiment, pre-installation can be executed further efficiently by the command processing of the SSD 40.

Further, in the present embodiment, the multi-bit cells are QLCs.

Thus, since the data retention characteristic (data retention period) is short in QLCs for storing 4 bits of data in one memory cell, the chance of corrupted data (including the program) particularly pre-installed in a suitable manner can be reduced.

Further, the pre-installation method according to the present embodiment is a pre-installation method of the information processing apparatus 1 including the SSD 40 having the SLC area SA1 (first storage area) and the QLC area QA1 (second storage area), and the main control unit 10 (control unit) which executes information processing based on the programs and data stored on the SSD 40, the pre-installation method including a first step, a second step, and a third step. Here, the first storage area (SLC area SA1) is a storage area of single bit cells in which one bit of data is stored in one memory cell. Further, the second storage area (QLC area QA1) is a storage area of multi-bit cells in which multiple bits of data are stored in one memory cell. In the first step (for example, step S101 of FIG. 4), the main control unit 10 stores, in the SLC area SA1, the installation program which executes processing for installing the programs and data preloaded on the SSD 40 at the time of shipment. In the second step (for example, step S102 and step S103 of FIG. 4), the main control unit 10 executes the installation program to install, in the storage area of the SSD 40 including the QLC area QA1, the program (pre-installed program) and data to be preloaded. In the third step (for example, step S104 of FIG. 4), the main control unit 10 moves, to the SLC area SA1, the program (pre-installed program) and data, which are stored in the QLC area QA1 and to be preloaded on the SSD 40.

Thus, the pre-installation method according to the present embodiment has the same effect as the above-described manufacturing method of the information processing apparatus 1, and the chance of corrupted data (including the program) pre-installed on the SSD 40 can be reduced.

### Second Embodiment

Referring next to the accompanying drawings, a manufacturing method of the information processing apparatus 1 according to a second embodiment will be described.

In this embodiment, a modification when an area to which data in the QLC area QA1 is moved in the third manufacturing process (third step) is not present in the SLC area SA1 will be described.

In the present embodiment, when the size of programs and data stored in the QLC area QA1 and to be preloaded is larger than a free space of the SLC area SA1, the main control unit 10 changes the QLC area QA1 into the SLC area SA1 to secure the free space in the SLC area SA1. Then, the main control unit 10 moves the programs and data to be preloaded from the QLC area QA1 to the SLC area SA1.

Note that, since the basic hardware configuration of the information processing apparatus 1 and the SSD 40 in the present embodiment is the same as that in the first embodiment illustrated in FIG. 1, the description thereof will be omitted here.

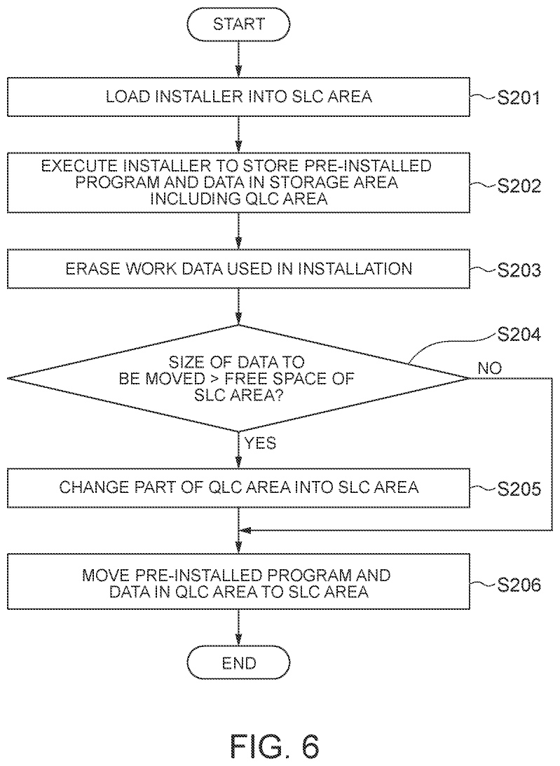

Referring next to FIG. 6, a pre-installation process in a manufacturing method of the information processing apparatus 1 according to the present embodiment to perform pre-installation on the information processing apparatus 1 will be described.

FIG. 6 is a flowchart illustrating an example of processing in the pre-installation process of the information processing apparatus 1 according to the present embodiment.

Since processing from step S201 to step S203 in FIG. 6 is the same as the above-described processing from step S101 to step S103 illustrated in FIG. 4, the description thereof will be omitted here.

Next, in step S204, the main control unit 10 determines whether the size of data to be moved is larger than the free space of the SLC area SA1 or not (size of data to be moved>free space of SLC SA1?). When the size of data to be moved is larger than the free space of the SLC area SA1 (size of data to be moved>free space of SLC SA1) (step S204: YES), the main control unit 10 proceeds to processing in step S205. On the other hand, when the size of data to be moved is equal to or smaller than the free space of the SLC area SA1 (size of data to be moved 5 free space of SLC SA1) (step S204: NO), the main control unit 10 proceeds to processing in step 3206.

In step S205, the main control unit 10 changes part of the QLC area QA1 into the SLC area SA1. The main control unit 10 changes part of the dynamic QLC area QA12 illustrated in FIG. 2 into the dynamic SLC area SA12 to secure the free space of the SLC area SA1. When the dynamic QLC area QA12 is changed into the dynamic SLC area SA12, since the storage capacity becomes (¼), the main control unit 10 is required to change, into the dynamic SLC area SA12, part of the dynamic QLC area QA12 corresponding to four times the insufficient capacity of the SLC area SA1. After the processing in step S205, the main control unit 10 proceeds to processing in step S206.

In step S206, the main control unit 10 moves the pre-installed programs and data in the QLC area QA1 to the SLC area SA1. Since the processing in step S206 is the same as the above-described processing in step S104 illustrated in FIG. 4, the description thereof will be omitted here. After the processing in step S206, the main control unit 10 ends the processing in the pre-installation process.

In the above-described processing of FIG. 6, the processing in step S201 corresponds to the first manufacturing process (first step) in the pre-installation process, step S202 and step S203 correspond to the second manufacturing process (second step) in the pre-installation process. Further, the processing from step S204 to step S206 correspond to the third manufacturing process (third step) in the pre-installation process.

As described above, in the manufacturing method (pre-installation method) of the information processing apparatus 1 according to the present embodiment, the SSD 40 can make the multi-bit cells of the QLC area QA1 function as single bit cells to change the QLC area QA1 into the SLC area SA1. In the third manufacturing process (third step), when the size of the programs and data stored in the QLC area QA1 and to be preloaded is larger than the free space of the SLC area SA1, the main control unit 10 changes the QLC area QA1 into the SLC area SA1 in order to secure the free space of the SLC area SA1. Then, the main control unit 10 moves the programs and data to be preloaded from the QLC area QA1 to the SLC area SA1.

Thus, in the manufacturing method (pre-installation method) of the information processing apparatus 1 according to the present embodiment, even when the SLC area SA1 is out of disk space, the QLC area QA1 can be changed into the SLC area SA1 to move the program (pre-installed program) and data to be preloaded from the QLC area QA1 to the SLC area SA1 properly.

In the normal operating state where the information processing apparatus 1 is used by an end user, since the memory controller 42 of the SSD 40 manages the data retention to perform rewriting properly, the end user does not need to care about corrupted data stored in the QLC area QA1.

However, the present disclosure is not limited to each of the above-mentioned embodiments, and changes can be made without departing from the scope of the present disclosure.

For example, in each of the above-mentioned embodiments, the example in which the memory controller 42 of the SSD 40 executes the processing for moving data from the QLC area QA1 to the SLC area SA1 by the special command is described, but the present disclosure is not limited thereto. For example, the main control unit 10 may also use control of a normal SSD 40 to move data from the QLC area QA1 to the SLC area SA1 without providing the special command for the SSD 40.

Further, in each of the above-mentioned embodiments, the example in which the information processing apparatus 1 is the laptop personal computer is described, but the present disclosure is not limited to this example. For example, the information processing apparatus 1 may be any other information processing apparatus such as a desktop personal computer or a tablet terminal.

Further, in each of the above-mentioned embodiments, the example in which the QLC is used as each multi-bit cell on the SSD 40 is described, but the present disclosure is not limited to this example. For example, the multi-bit cell may also be an MLC (Multi Level Cell) in which data corresponding to 2 bits is stored in one memory cell, a TLC (Triple Level Cell) in which data corresponding to 3 bits is stored in one memory cell, or the like.

Further, in each of the above-mentioned embodiments, the example in which the memory cells of the flash memories 41 are charge-trap type memory cells is described, but the present disclosure is not limited to this example. The memory cells may also be floating gate type memory cells having floating gates.

Further, the example in which the main control unit 10 mainly executes the processing step S204 and step S205 in the above-mentioned processing of FIG. 6 is described, but the present disclosure is not limited to this example. The SSD 40 may also execute the processing of these steps.

Further, in currently popular technology, since it is common that the memory controller 42 of the SSD 40 selects the storage area of the SSD 40, the memory controller 42 may also select, as a control entity, the SLC area SA1 and the QLC area QA1 in the processing illustrated in FIG. 4 and FIG. 6.

Further, in the first manufacturing process described above, the example in which the installation program is stored in the SLC area SA1 (first storage area) is described, but the present disclosure is not limited to this example. The installation program may also be stored in the QLC area QA1.

Note that each of the components included in the information processing apparatus 1 and the SSD 40 has a computer system therein. Then, a program for implementing the function of each of the components included in the electronic apparatus 1 and the SSD 40 described above may be recorded on a computer-readable recording medium so that the program recorded on this recording medium is read into the computer system and executed to perform processing in each component included in the electronic apparatus 1 and the SSD 40 described above. Here, the fact that “the program recorded on the recording medium is read into the computer system and executed” includes installing the program on the computer system. It is assumed that the “computer system” here includes the OS and hardware such as peripheral devices and the like.

Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the electronic apparatus 1 and the SSD 40, or delivery servers for delivering respective divided pieces of the program may be different from one another. Further, the “computer-readable recording medium” includes a medium on which the program is held for a given length of time, such as a volatile memory (PAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the above-described functions may be realized as an integrated circuit such as LSI (Large Scale Integration). Each of the above-described functions may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

1. A method of manufacturing an information processing apparatus, comprising:
storing, in a first storage area of an solid-state drive (SSD) of the information processing apparatus, an installation program which when executed causes the information processing apparatus to install preload data;
executing the installation program to install the preload data at least partially in a second storage area of the SSD; and
after executing the installation program, moving portions of the preload data stored in the second storage area to the first storage area of the SSD, wherein
the first storage area is configured to store single bit cells in which one bit of data is stored in one memory cell, and the second storage is configured to store multi-bit cells in which multiple bits of data are stored in one memory cell.

2. The method of manufacturing according to claim 1, wherein
the step of executing the installation program includes moving data stored in the first storage area to the second storage area to free up a working data area in the first storage area and erasing the working data area when ending the execution of the installation program, and
the step of moving the preload data includes moving at least a portion of the preload data to the working data area of the first storage area.

3. The method of manufacturing according to claim 1, wherein
the SSD is configured to execute command processing for moving data between the first storage area and the second storage area, and
the step of moving the preload data includes controlling the SSD to move the portions of the preload data stored in the second storage area to the first storage area.

4. The method of manufacturing according to claim 1, wherein
the first storage area and the second storage area are both at least partially part of a dynamic storage area of the SSD, the dynamic storage area being dynamic memory cells which are switchable between the first storage area and the second storage area.

5. The method of manufacturing according to claim 4, wherein
the step of moving the preload data includes moving at least a portion of the preload data to the dynamic storage area of the SSD.

6. The method of manufacturing according to claim 4, wherein
the step of moving the preload data includes controlling the SSD to switch at least a portion of the dynamic storage area from the second storage area to the first storage area.

7. The method of manufacturing according to claim 4, further comprising:
prior to executing the installation program, controlling the SSD to switch at least a portion of the dynamic storage area from the first storage area to the second storage area.

8. A manufacturing method of an information processing apparatus including a solid-state drive (SSD) and a control unit, the SSD having a first storage area as a storage area of single bit cells in which one bit of data is stored in one memory cell, and a second storage area as a storage area of multi-bit cells in which multiple bits of data are stored in one memory cell, the control being configured to execute information processing based on programs and data stored on the SSD, the manufacturing method comprising:
a first manufacturing process in which the control unit stores, on the SSD, an installation program which executes processing for installing preload data to be preloaded on the SSD at a time of shipment;
a second manufacturing process in which the control unit executes the installation program to install, at least partially in the second storage area, the preload data; and
a third manufacturing process in which the control unit moves, to the first storage area, the preload data stored in the second storage area.

9. A mobile computer, comprising:
a solid-state drive (SSD) including a dynamic storage area which is switchable between a first storage area and a second storage area, the first storage area being configured to store single bit cells in which one bit of data is stored in one memory cell, the second storage being configured to store multi-bit cells in which multiple bits of data are stored in one memory cell; and
a controller coupled to the SSD, wherein the controller is configured to:
store preload data on the first storage area of the dynamic storage area of the SSD, and
upon the mobile computer being booted up for a first time after storing the preload data, moving the preload data to the second storage area of the dynamic storage area of the SSD.

10. The mobile computer of claim 9, wherein
the controller is further configured to, after moving the preload data to the second storage area, control the SSD to switch the first storage area of the dynamic storage area of the SSD to become the second storage area.
